(19) United States
(12) Patent Application Publication
(10) Pub. No.: US 2025/0343665 A1
(43) Pub. Date: Nov. 6, 2025

(54) License-Exempt Frequency Band Control of Wireless Links

(71) Applicant: Telefonaktiebolaget LM Ericsson (publ), Stockholm (SE)

(72) Inventors: Jonas Sedin, Brentford (GB); Abhishek Ambede, Huddinge (SE); Rocco Di Taranto, Lund (SE); Sebastian Max, Cologne (DE); Guido Roland Hiertz, Aachen (DE)

(21) Appl. No.: 18/855,487

(22) PCT Filed: Apr. 21, 2022
(86) PCT No.: PCT/EP2022/060549

§ 371 Date: Oct. 9, 2024

(51) Int. Cl. H04L 5/00; H04W 76/19

(52) U.S. Cl. CPC H04L 5/0098; H04W 76/19

(57) ABSTRACT

A wireless device (11) associates with an access point (10) of the wireless communication system. Based on signaling in an license-exempt frequency band (320). the wireless device (11) controls multiple wireless links (315, 325) between the wireless device (11) and the access point (10). The multiple wireless links (315, 325) comprise at least one wireless link (325) in the license-exempt frequency band (320) and an additional wireless link in a licensed frequency band (315).

### TECHNICAL FIELD

The present invention relates to methods for controlling wireless transmissions and to corresponding devices, systems, and computer programs.

### BACKGROUND

Wireless communication technologies may use licensed frequency bands and/or license-exempt frequency bands. A typical example of a wireless communication technology operating in license-exempt frequency bands is the WLAN (Wireless Local Area Network) technology, also referred to as “Wi-Fi”, according to “IEEE Standard for Information Technology—Telecommunications and Information Exchange between Systems-Local and Metropolitan Area Networks—Specific Requirements-Part 11: Wireless LAN Medium Access Control (MAC) and Physical Layer (PHY) Specifications,” in IEEE Std 802.11-2020 (Revision of IEEE Std 802.11-2016), pp. 1-4379, 26 Feb. 2021, in the following denoted as “IEEE 802.11 Standard”.

The WLAN technology may also operate in licensed frequency bands. For example, “802.11y-2008 IEEE Standard for Information technology—Local and metropolitan area networks—Specific requirements—Part 11: Wireless LAN Medium Access Control (MAC) and Physical Layer (PHY) Specifications Amendment 3:3650-3700 MHz Operation in USA”, in the following denoted as “IEEE 802.11y-2008 Amendment”, specifies methods to enable efficient operation in licensed frequency bands, especially the 3.65 GHz (3650 MHz to 3700 MHz) band in the USA. This band is sometimes also considered as being “lightly” licensed. Licenses may be easily acquired and license owners must register in an FCC (Federal Communications Commission) database. The IEEE 802.11y-2008 Amendment defines a set of procedures for connecting to an access point (AP) in the licensed frequency band and for announcing the position of the network and more. The IEEE 802.11y-2008 Amendment was incorporated into the current IEEE 802.11 Standard.

Subclause 4.3.12, entitled “Operation in licensed frequency bands”, of the IEEE 802.11 Standard defines how WLAN devices, typically denoted as STA (“station”), can operate on frequencies that are licensed by national regulatory bodies, including Dynamic STA Enablement (DSE) in licensed frequency bands and Contention Based Protocol (CBP) in nonexclusively licensed frequency bands.

The DSE procedures are used to automate channel provisioning and to enforce regulatory requirements. The STAs must not operate in the licensed frequency band if such STAs have not been enabled. Such STAs are denoted as dependent STAs. In some licensed frequency bands, wireless devices can be owned and operated by individuals who do not hold a license. For these wireless devices, permission to operate depends on communicating with or receiving permission from a STA that is maintained by a licensed operator. The latter STA is denoted registered STA. Until a dependent STA receives such permission, the dependent STA must be completely passive. A registered STA transmits indication messages that permit dependent STAs to transmit enablement request messages. Upon reception of such indication, a dependent STA may request the registered STA to enable it. The registered STA's indication also contains requirements that STAs must comply with when operating in the licensed frequency band. Registered STAs indicate this permission regularly by including a special information element in a beacon which by default is transmitted every 102.4 ms. A dependent STA loses the permission to transmit in the licensed spectrum either by receiving a deregistration message, or if it has not received the enabling signal, i.e., the information element in the beacon, for a configurable duration. The default value of this configurable duration is 60 s.

The CBP in nonexclusively licensed frequency bands considers that the granting of licenses on nonexclusive, uncoordinated basis in the same area may result in overlapping WLANs. When overlapping WLANs cause co-channel interference, regulations typically require the use of a CBP by which a transmitter provides reasonable opportunities for other transmitters to operate. Here, the IEEE 802.11 Standard for example specifies a CSMA/CA (Carrier Sensing Multiple Access with Collision Avoidance) mechanism. In many situations, the CSMA/CA mechanism allows for providing fair access to the wireless medium while at the same time avoiding collisions.

In some cases, DSE STA identification may be used to resolve interference: When the CSMA/CA mechanism is not able to sufficiently sense the presence of another licensee's STA, which would then be a hidden STA, or if a secondary licensee causes interference to a primary licensee, the secondary licensee is obliged to resolve complaints that result from interference caused by any STA under its control, including dependent STAs. To facilitate the interference resolution process, all STAs operating in licensed spectrum use DSE STA identification and location information procedures.

The DSE STA identification and location information procedures are tied because, by default, registered STAs broadcast their actual location as their unique identifier. Dependent STAs broadcast the location of the STA that has enabled them as well as a unique code selected by the licensee. This method puts a victim of the interference in contact with the party responsible for rectifying the problem, and at the same time it protects the privacy of the dependent STA's operator.

Some optional mechanisms of the WLAN technology, when used together, help to meet general requirements for spectrum sharing, incumbent detection, and other cognitive radio functions in licensed frequency bands. Such mechanisms for each frequency band are detailed in in Annex E.2 of IEEE 802.11 Standard.

For example, E.2.2 subclause “3650-3700 MHz band in the United States” reports that regulations specify the following:
Certified mobile and portable STAs do not need to be registered, but they “must” operate under the control of an enabling STA (using DSE procedures).
A registered STA “must” be a fixed STA.
A registered STA “must” not operate as enabling STA until the licensee has registered it as a “base station” in the Universal Licensing System (ULS).
Enabling STAs and fixed STAs are registered STAs. Dependent non-AP STAs and dependent APs are dependent STAs.
A STA shall use a) CCA-ED (clear channel assessment energy detection), b) CS/CCA (carrier sense/clear channel assessment), c) TPC (transmit power control), d) DFS (dynamic frequency selection).

An enhancement of the WLAN technology referred to as EHT (Extremely High Throughput), to be introduced with an amendment denoted as IEEE 802.11be, is planned to be certified as Wi-Fi 7. The EHT technology is for example described in IEEE draft “IEEE P802.11be/D1.5”, March 2022, in the following denoted as EHT draft. Planned features of the EHT technology include increased throughput, multi-link (ML) operation, multi-RU (resource unit) allocation, up to 320 MHz channel bandwidths, and 4096-QAM modulation. A feature for latency reduction, namely Restricted Target Wake Time (rTWT) has also been introduced. To further extend the trigger-based scheduling capabilities, the EHT technology also supports single user trigger-based uplink transmissions, wherein an AP can trigger a single STA to perform trigger-based channel access and transmit a trigger based single-user data frame in uplink.

In ML, a device termed as a multi-link device (MLD) has multiple affiliated STAs, each of which can communicate using independent wireless channels, also referred to as links. Communication over multiple links by an MLD is termed as multi-link operation (MLO). For example, an MLD can have two affiliated STAs, one communicating using a channel in the 5 GHz frequency band and the other communicating using a channel in the 6 GHz frequency band. Alternatively, as another example, an MLD can have two affiliated STAs, each communicating using channels in the 6 GHz frequency band. An AP MLD means an MLD with two or more affiliated AP STAs. A non-AP MLD corresponds to an MLD with two or more affiliated non-AP STAs.

As regards the ML architecture considered for the EHT technology, it should be noted that from a higher-layer perspective, the MLD still appears as a single device despite having several links on the same or different frequency bands. This means that there is a single MAC-Service Access Point (MAC-SAP) and that there is only one logical association between an AP and a non-AP. Since a set of the functions that are done on MAC-level needs to be done per STA, i.e., per link, such as the construction of Aggregated MAC PDUs, and another set of functions needs to be per-MLD level, the ML architecture can be considered as providing an upper MAC layer and a lower MAC layer: There is a single upper MAC entity per MLD, and there are multiple lower MAC entities per MLD, one for each link. The addressing in such ML architecture may work by each link having its own separate MAC address per link, and providing a separate MAC address that is per-MLD to address the MLD.

Concerning ML association, Section 35.3.5.1, entitled “Multi-link (re)setup procedure” of the EHT Draft describes that, for a non-AP MLD to perform multi-link (re)setup with an AP MLD, the non-AP MLD and the AP MLD shall exchange (Re)Association Request/Response frames and shall follow the MLD (re)association procedure as described in Section 11.3 of the IEEE 802.11 Standard-2020. A (Re)Association Request/Response frame exchange is for an ML setup if both frames carry a Basic Multi-Link element. Otherwise, the (Re)Association Request/Response frame exchange is not for ML setup.

In the (Re)Association Request frame, the non-AP MLD indicates the links that are requested for (re)setup and the capabilities and operational parameters of the requested links. The non-AP MLD may request to (re)set up links with a subset of APs affiliated with the AP MLD. In the (Re)Association Response frame, the AP MLD shall indicate the requested links that are accepted and the requested links that are rejected for (re)setup and the capabilities and operational parameters of the requested links. The AP MLD may not accept all the links that are requested for (re)setup. The AP MLD may accept a subset of the links that are requested for (re)setup. The (Re)Association Response frame shall be sent to the non-AP STA affiliated with the non-AP MLD that sent the (Re)Association Request frame. For each setup link, the corresponding non-AP STA affiliated with the non-AP MLD is in the same associated state as the non-AP MLD and is associated with the corresponding AP affiliated with the AP MLD, without providing the corresponding non-AP STA to the corresponding AP mapping to the distribution system (DS).

However, the ML features of the EHT technology do not consider the possibility of using a licensed frequency band for one or more of the multiple links, e.g., a lightly licensed frequency band like the 3.65 GHz to 3.70 GHz frequency band, which is subject to special requirements and regulations. Accordingly, such licensed frequency band is potentially not usable for MLDs, or the required management procedures can make usage of the licensed frequency band slow and inefficient. Examples of such limitations are the mechanisms to enable a STA before it is allowed to transmit in the licensed frequency band, or a STA's inability to turn its radio in the licensed frequency band into power-save mode for an extended longer duration without losing its enablement.

Accordingly, there is a need for techniques which allow for efficiently using ML operation also in a licensed frequency band.

### SUMMARY

According to an embodiment, a method of controlling wireless transmissions in a wireless communication system is provided. According to the method, a wireless device associates with an access point of the wireless communication system. Based on signaling in an license-exempt frequency band, the wireless device controls multiple wireless links between the wireless device and the access point. The multiple wireless links comprise at least one wireless link in the license-exempt frequency band and an additional wireless link in a licensed frequency band.

According to a further embodiment, a method of controlling wireless transmissions in a wireless communication system is provided. According to the method, an access point of the wireless communication system associates with a wireless device. Based on signaling in an license-exempt frequency band, the access point controls multiple wireless links between the wireless device and the access point. The multiple wireless links comprise at least one wireless link in the license-exempt frequency band and an additional wireless link in a licensed frequency band.

According to a further embodiment, a wireless device for a wireless communication system is provided. The wireless device is configured to associate with an access point of the wireless communication system. Further, the wireless device is configured to, based on signaling in an license-exempt frequency band, control multiple wireless links between the wireless device and the access point. The multiple wireless links comprise at least one wireless link in the license-exempt frequency band and an additional wireless link in a licensed frequency band.

According to a further embodiment, a wireless device for a wireless communication system is provided. The wireless device comprises at least one processor and a memory. The memory contains instructions executable by said at least one processor, whereby the wireless device is operative to associate with an access point of the wireless communication system. Further, the memory contains instructions executable by said at least one processor, whereby the wireless device is operative to, based on signaling in an license-exempt frequency band, control multiple wireless links between the wireless device and the access point. The multiple wireless links comprise at least one wireless link in the license-exempt frequency band and an additional wireless link in a licensed frequency band.

According to a further embodiment, an access point for a wireless communication system is provided. The access point is configured to associate with a wireless device. Further, the access point is configured to, based on signaling in an license-exempt frequency band, control multiple wireless links between the wireless device and the access point. The multiple wireless links comprise at least one wireless link in the license-exempt frequency band and an additional wireless link in a licensed frequency band.

According to a further embodiment, an access point for a wireless communication system is provided. The access point comprises at least one processor and a memory. The memory contains instructions executable by said at least one processor, whereby the access point is operative to associate with a wireless device. Further, the memory contains instructions executable by said at least one processor, whereby the access point is operative to, based on signaling in an license-exempt frequency band, control multiple wireless links between the wireless device and the access point. The multiple wireless links comprise at least one wireless link in the license-exempt frequency band and an additional wireless link in a licensed frequency band.

According to a further embodiment, a computer program or computer program product is provided, e.g., in the form of a non-transitory storage medium, which comprises program code to be executed by at least one processor of a wireless device. Execution of the program code causes the wireless device to associate with an access point of the wireless communication system. Further, execution of the program code causes the wireless device to, based on signaling in an license-exempt frequency band, control multiple wireless links between the wireless device and the access point. The multiple wireless links comprise at least one wireless link in the license-exempt frequency band and an additional wireless link in a licensed frequency band.

According to a further embodiment, a computer program or computer program product is provided, e.g., in the form of a non-transitory storage medium, which comprises program code to be executed by at least one processor of an access point of a wireless communication system. Execution of the program code causes the access point to associate with a wireless device. Further, execution of the program code causes the access point to, based on signaling in an license-exempt frequency band, control multiple wireless links between the wireless device and the access point. The multiple wireless links comprise at least one wireless link in the license-exempt frequency band and an additional wireless link in a licensed frequency band.

Details of such embodiments and further embodiments will be apparent from the following detailed description.

### BRIEF DESCRIPTION OF THE DRAWINGS

FIG. 1 schematically illustrates a wireless communication system according to an embodiment.

FIG. 2 schematically illustrates an example of a ML architecture as used according to an embodiment.

FIGS. 3A, 3B, and 3C illustrates ML setup procedures according to various embodiments.

FIG. 4 shows a flowchart for schematically illustrating a method according to an embodiment.

FIG. 5 shows a block diagram for schematically illustrating functionalities of a wireless device according to an embodiment.

FIG. 6 shows a flowchart for schematically illustrating a further method according to an embodiment.

FIG. 7 shows a block diagram for schematically illustrating functionalities of an access point according to an embodiment.

FIG. 8 schematically illustrates structures of an access point according to an embodiment.

FIG. 9 schematically illustrates structures of a wireless device according to an embodiment.

### DETAILED DESCRIPTION

In the following, concepts in accordance with exemplary embodiments of the invention will be explained in more detail and with reference to the accompanying drawings. The illustrated embodiments relate to controlling of wireless transmissions in a wireless communication system. The wireless communication system may be a WLAN system based on a IEEE 802.11 technology. However, it is noted that the illustrated concepts could also be applied to other wireless communication technologies, e.g., to contention-based modes of the LTE (Long Term Evolution) or NR (New Radio) technology specified by 3GPP (3^{rd} Generation Partnership Project).

According to the illustrated concepts, usage of a license-exempt frequency band and a licensed frequency band can be combined in ML communication between a wireless device to an access point (AP). The licensed frequency band can be a lightly licensed frequency band like the 3.65 GHz (3650 MHz to 3700 MHz) band in the USA. In such case, the wireless device itself does not need to be licensed to operate in the licensed frequency band. Rather, the AP may be licensed to operate in the licensed frequency band and can enable the wireless device to operate in the licensed frequency band. The ML communication involves simultaneously maintaining multiple wireless links between the wireless device and the AP. The wireless device can be a non-AP STA and will in the following also be referred to as non-AP MLD. The AP will in the following also be denoted as AP MLD. For setting up the ML association, information may be signaled on the license-exempt frequency band. For example, information needed to access a wireless channel in the licensed frequency band may be broadcasted on the license-exempt frequency band. In some scenarios, such information may be additionally broadcasted in the licensed frequency band. In some scenarios, the signaled information may also include an indication that the non-AP MLD should perform association to the AP on certain preferred channel from a license-exempt frequency band, rather than on a channel from the licensed frequency band.

In the illustrated concepts, the non-AP MLD can efficiently and smoothly use both the license-exempt frequency band and the licensed frequency band, leveraging the characteristics of the different frequency bands. For example, the non-AP MLD can use a small bandwidth channel in the licensed frequency band for critical traffic, and a large bandwidth channel in the license-exempt frequency band for broadband service. This may in turn contribute to a better overall use of the available resources in the licensed frequency band and the license-exempt frequency band. As regards the usage of the licensed frequency band, the non-AP MLD can be quickly enabled to operate in the licensed frequency band, by performing signaling for association of the non-AP MLD to the AP MLD in the license-exempt frequency band.

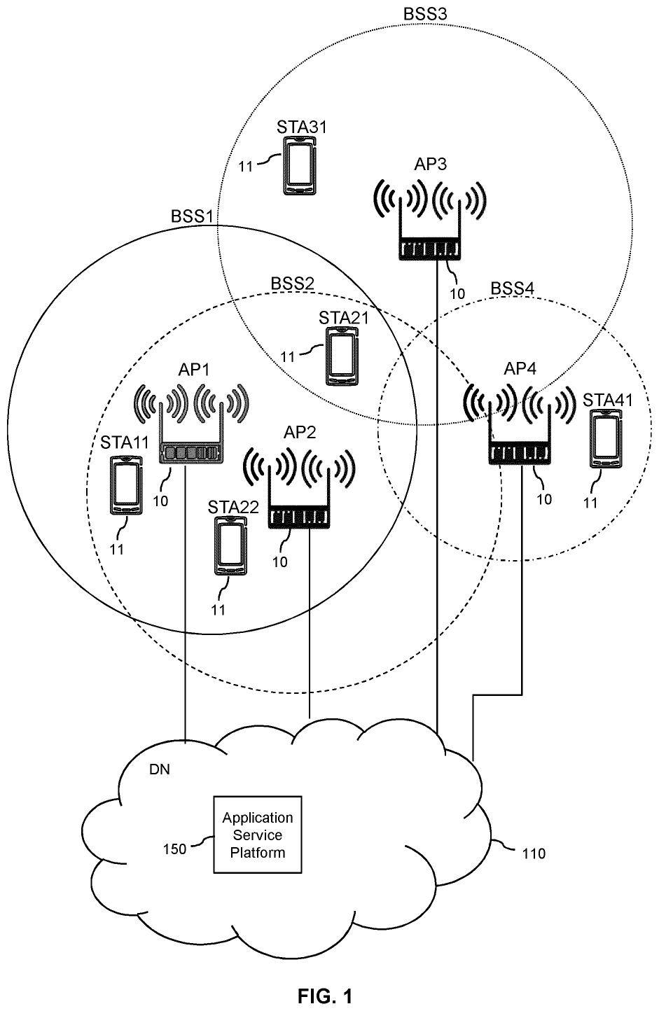

FIG. 1 illustrates an exemplary wireless communication system according to an embodiment. In the illustrated example, the wireless communication system includes multiple APs 10, in the illustrated example referred to as AP1, AP2, AP3, AP4, and multiple stations 11, in the illustrated example referred to as STA11, STA21, STA22, STA31, and STA41. STA11 is served by AP1 (in a first BSS denoted as BSS1), STA21 and STA22 are served by AP2 (in a second BSS denoted as BSS2), STA31 is served by AP3 (in a third BSS denoted as BSS3), and STA41 is served by AP4 (in a fourth BSS denoted as BSS4). The stations 11 may be non-AP STAs and correspond to various kinds of wireless devices, for example user terminals, such as mobile or stationary computing devices like smartphones, laptop computers, desktop computers, tablet computers, gaming devices, or the like. Further, the stations 11 could for example correspond to other kinds of equipment like smart home devices, printers, multimedia devices, data storage devices, or the like.

In the example of FIG. 1, each of the stations 11 may connect through a radio link to one of the APs 10. For example depending on location or channel conditions experienced by a given station 11, the station 11 may select an appropriate AP 10 and BSS for establishing the radio link. The radio link may be based on one or more OFDM carriers from a frequency spectrum which is shared on the basis of a contention based mechanism, e.g., an unlicensed or license-exempt frequency band like the 2.4 GHz ISM band, the 5 GHz band, the 6 GHz band, or the 60 GHz band.

Each AP 10 may provide data connectivity of the stations 11 connected to the AP 10. As further illustrated, the APs 10 may be connected to a data network (DN) 110. In this way, the APs 10 may also provide data connectivity between stations 11 connected to different APs 10. Further, the APs 10 may also provide data connectivity of the stations 11 to other entities, e.g., to one or more servers, service providers, data sources, data sinks, user terminals, or the like. Accordingly, the radio link established between a given station 11 and its serving AP 10 may be used for providing various kinds of services to the station 11, e.g., a voice service, a multimedia service, or other data service. Such services may be based on applications which are executed on the station 11 and/or on a device linked to the station 11. By way of example, FIG. 1 illustrates an application service platform 150 provided in the DN 110. The application(s) executed on the station 11 and/or on one or more other devices linked to the station 11 may use the radio link for data communication with one or more other stations 11 and/or the application service platform 150, thereby enabling utilization of the corresponding service(s) at the station 11.

In the illustrated concepts, it is assumed that at least some of the illustrated APs 10 and stations 11 are MLDs. For example, AP1 and STA11 could be MLDs and thus setup ML connections for providing the data connectivity. Further, it is assumed that such AP MLD 10 is licensed to operate in a licensed frequency band, e.g., in a lightly licensed frequency band like the 3.65 GHz band. The station 11 served by the AP 10 may in turn require enablement from the licensed AP 10 to operate in the licensed frequency band.

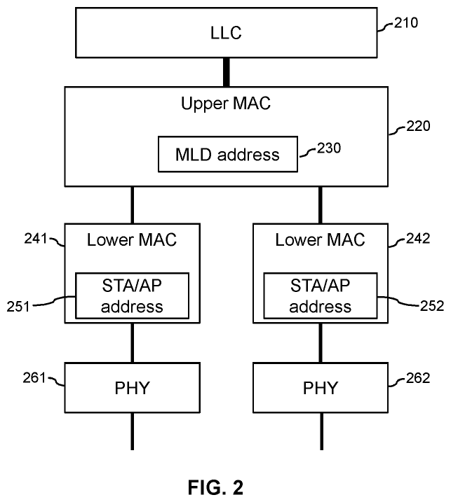

FIG. 2 illustrates an example of a ML architecture that may be used in the AP 10 and the station 11. The ML architecture of FIG. 2 may thus be applied in an MLD which can be either a non-AP MLD, like one of the above-mentioned stations 11, or an AP MLD, like one of the above-mentioned APs 10. As illustrated, the ML architecture corresponds to a layered architecture, with a PHY (Physical) layer, a MAC (Medium Access Control) layer, and one or more higher layers. By way of example, the one or more higher layers are illustrated as inkling an LLC (Logical Link Control) layer 210. From perspective of the higher layers, the MLD appears as a single device despite having several links on the same or different frequency bands, and despite such different links corresponding to different affiliated STAs of the MLD. There is a single MAC-SAP between the MAC layer and the higher layers. An upper MAC entity 220 is provided for MAC-level functions that are provided on a per-MLD level. For MAC-level functions that are provided on a per link level, such as the construction of Aggregated MAC PDUs, a corresponding lower MAC entity 241, 242 is provided for each of the multiple links. The ML architecture of FIG. 2 can thus be considered as providing an upper MAC layer and a lower MAC layer: There is a single upper MAC entity per MLD, and there are multiple lower MAC entities per MLD, one for each link. The addressing in such ML architecture may work by each link having its own separate MAC address 251, 252 per link. A separate MAC address 230 is provided per-MLD to address the MLD.

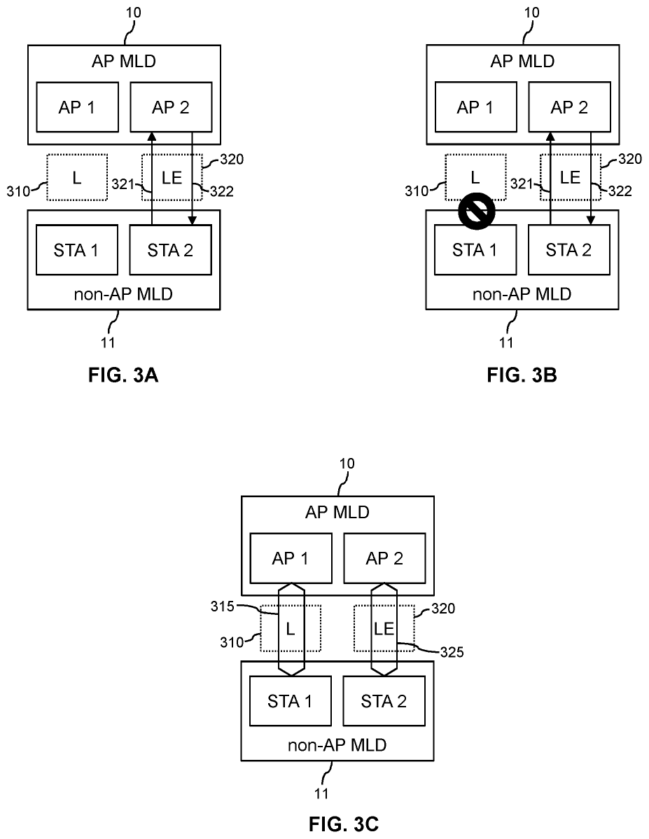

In the illustrated concepts, a non-AP MLD may perform ML association on a channel which is in a license-exempt frequency band, e.g., like the 2.4 GHz ISM band, the 5 GHz band, the 6 GHz band, or the 60 GHz band. Based on the ML association the non-AP MLD establishes and typically also configures a wireless link in the licensed frequency band. As an example, the non-AP MLD may send an ML association request on a channel in the license-exempt frequency band and use this ML association request to signal that the non-AP MLD also intends to establish a wireless link in the licensed frequency band. FIGS. 3A, 3B, and 3C illustrate examples of corresponding procedures.

The example of FIGS. 3A, 3B, and 3C involves an AP MLD 10, e.g., one of the APs 10 of FIG. 1, and a non-AP MLD 11, e.g., one of the station 11 of FIG. 1. The AP MLD 10 is licensed to operate in a licensed (L) frequency band 310, e.g., the 3.65 GHz band. Further, the AP MLD and the non-AP MLD both support operation in a license-exempt (LE) frequency band 320, e.g., the 2.4 GHz ISM band, the 5 GHz band, the 6 GHz band, or the 60 GHz band. As further illustrated, the AP MLD has two affiliated APs, denoted as AP 1 and AP 2, one for each link 10 which can be simultaneously maintained. Similarly, the non-AP MLD has two affiliated non-AP STAs, one for each link that can be simultaneously maintained.

As illustrated in FIG. 3A, the non-AP MLD 11 and the AP MLD 10 may perform ML association in the license-exempt frequency band 320. In the illustrated example, the ML association involves that the non-AP MLD 11 sends a ML association request 321 to the AP MLD 10. The ML association request 321 may indicate that the non-AP MLD 11 requests establishment of a link also in the licensed frequency band 310. The AP MLD 10 responds by sending a ML association response 322 to the non-AP MLD 11. The ML association response 322 can indicate either acceptance or rejection of the requested ML association. If the requested ML association is accepted, the ML association response message may include additional information concerning access or usage of the licensed frequency band 310 and the license-exempt frequency band 320, e.g., information on maximum transmit power, maximum transmission duration. Such information may in particular include mandatory regulatory parameters that apply in the licensed frequency band 310 and/or in the license-exempt frequency band 320. Furthermore, the ML association response 322 may include information related to maximum channel usage and minimum traffic classes mandated for use in the licensed frequency band 320.

In the specific case of a licensed frequency band to which the regulatory requirements specified in the IEEE 802.11y Amendment apply, the above signaling can be implemented by including the “Supported Operating Classes” information element in the ML Association Request 321 from the non-AP MLD 11, and by indicating the operating classes of the licensed frequency band in the “Supported Operating Classes” information element. The AP MLD 10 may then include the “Registered DSE Location” information element in the ML association response 322. The above-mentioned information elements could be included as additional information elements in the ML association request 321 and ML association response 322, or they could be included as part of the STA profile of ML information elements.

For operation of the non-AP MLD 11 and the AP MLD 10 in the licensed frequency band 310 based on the principle of the IEEE 802.11y Amendment, each of the AP STAs affiliated with the AP MLD 10 may acts as a “registered STA”. Accordingly, any AP STA affiliated with AP MLD 11 (in FIGS. 3A and 3B, any of AP 1 and AP 2) is authorized to enable a non-AP STA (in FIGS. 3A and 3B, any of STA 1 and STA 2) to operate in the licensed frequency band 310. Upon enablement such non-AP STA would become a “dependent STA” of the enabling AP STA in the AP MLD 10.

In some scenarios, usage of the licensed frequency band 310 by the non-AP MLD 11 could also be enabled through a ML re-configuration procedure. In such case, ML association may first be completed for the license-exempt frequency band 320, and operation in the licensed frequency band 310 subsequently activated by performing a ML reconfiguration procedure. In such case, the signaling as described above for the ML association request 321 and ML association response 322 can be implemented by a ML re-configuration request from the non-AP MLD 11 and a ML re-configuration response from the AP MLD 10.

In some scenarios, the AP MLD 11 may broadcast information needed to access the licensed frequency band 310. The AP MLD 11 may broadcast such information in both the license-exempt frequency band 310 and the licensed frequency band 320. The broadcasted information may include one or more of: license information, location information, transmit power transmission limitations, medium access methods, medium access requirements, and other regulatory requirements. If the regulatory requirements specified in the IEEE 802.11y Amendment apply to the licensed frequency band 310, the AP MLD 11 may broadcast Registered DSE frames as defined in the IEEE 802.11y Amendment. These Registered DSE frames signal the location of the AP MLD 11 operating in the licensed frequency band. Upon receiving such Registered DSE frame, the non-AP MLD 11 may learn that the Registered DSE location is available.

In some scenarios, the AP MLD 11 supplements the Registered DSE frames with information that indicates to which of its affiliated AP STAs the signaled Registered DSE location applies. This may be useful when there are multiple channels to which the Registered DSE frames could refer. For example, the AP MLD 11 could have multiple affiliated AP STAs which operate on different channels in the licensed frequency band 310.

In some cases, a single-link non-AP STAs, i.e., a non-MLD STA, may need to associate to the AP MLD 11 in the licensed frequency band 310. For example, such single-link non-AP STA could operate exclusively in the licensed frequency band 310. To enable association of such single-link non-AP STAs, the AP MLD 11 may broadcast beacon frames with information needed to access the licensed frequency band 310 in the licensed frequency band 310.

To reduce the amount of overhead in the licensed frequency band 310, the AP MLD 11 could also signal in the licensed frequency band that association requests are not accepted for non-AP MLDs in the licensed frequency band 310 or otherwise indicate that non-AP MLDs, like non-AP MLD 11, should perform ML association and/or probing on channels outside the licensed frequency band. It is noted that such indication would not exclude single-link non-AP STAs from performing association in the licensed frequency band 310. For non-AP MLDs that have at least one affiliated STA operating in license-exempt frequency band, like the non-AP MLD 11, the signaling by the AP MLD 10 may indicate that the ML association should be performed using a channel in the license-exempt frequency band 320. Such channel could for example be indicated as a “preferred association channel.” In the case of a non-AP MLD that has all its affiliated non-AP STAs operating in licensed frequency band, then the signaling from the AP MLD 10 may indicate that the association should be performed by using one or more signaled “preferred association channel(s)”. Thus, in either of the cases described here, the signaling can for instance be through a “preferred association channel”. The association procedure would thus be steered to be performed on the preferred association channel, while other channel(s) would be blocked for association purposes, as illustrated in FIG. 3B.

Such steering of the association procedure to the preferred association channel can be implemented as follows: The AP MLD 10 may signal then non-AP MLDs shall associate on the preferred association channel, which can be indicated in terms of link identifier (Link ID), channel, frequency band, and/or MAC address or MLD MAC address. In some scenarios, the AP MLD 11 could also just signals that association procedures should be performed outside the licensed frequency band 310. In some scenarios, the AP MLD 11 may refrain from signaling MLD information in beacons broadcasted in the licensed frequency band 310, thereby avoiding excessive beacon traffic in the licensed frequency band 310. In some cases, the AP MLD 11 could signal only limited MLD information in the licensed frequency band 310, which enables receiving non-AP MLDs to find another channel outside the licensed frequency band 310 on which the association procedure may be performed. For instance, such information may be limited to channel, frequency band, and MAC addresses used by the AP MLD 11, typically in the licensed frequency band 310 and the license-exempt frequency band 320.

If a non-AP MLD, e.g., like the non-AP MLD 11, received such signaling from the AP MLD 11, e.g., in a beacon on a channel in the licensed frequency band 310, it may deduce that the AP MLD 10 that transmitted the beacon is ML capable but that ML association should be performed on another channel, outside the licensed frequency band 310. The non-AP MLD may then use one of its affiliated STAs on a channel outside the licensed frequency band to acquire full ML information and then performs ML association on that other channel, including signaling that the non-AP MLD 11 requests establishing a connection in the licensed frequency band. The non-AP MLD 11 is then granted access to the licensed frequency band and may transmit or receive data on the link in the licensed frequency band, in parallel to transmissions on one or more link(s) in license-exempt frequency band(s).

Based on the information exchanged in the ML association, the AP MLD 10 and the non-AP MLD 11 establish a first link 315 in the licensed frequency band 310 and a second link 325 in the license-exempt frequency band 320, as illustrated in FIG. 3C. At this point, the non-AP MLD 11 and the AP MLD 10 can perform ML communication by simultaneously using a first link in the license-exempt frequency band 320 and a second link in the licensed frequency band 310, even though the licensed frequency band 310 may have been blocked for ML association purposes or other control signaling between the non-AP MLD 11 and the AP MLD 10.

In some situations, the AP MLD 10 may need to de-enable the non-AP MLD 11, i.e., to revoke the allowance of the non-AP MLD 11 to operate in the licensed frequency band 310. The presence of a mechanism to perform such de-enablement can constitute a regulatory requirement.

In the illustrated concepts, signaling for the de-enablement can be performed outside the licensed frequency band 11, e.g., on the link in the license-exempt frequency band 320. The de-enablement can for example involve that the AP MLD 10 uses the link in the license-exempt frequency band 320 to transmit a de-enablement command, e.g., a DSE de-enable frame, to the non-AP MLD 11. In some cases, the non-AP MLD 11 may have multiple affiliated non-AP STAs that operate in the license-exempt frequency band 320. In such cases, the non-AP MLD 11 should be configured to avoid that all affiliated non-AP STAs of the non-AP MLD 11 simultaneously are in a power-save mode, e.g., by allowing that at most all but one of the affiliated non-AP STAs that operate in license-exempt frequency band 320 may be in power-save mode. In this way, it can be ensured that the non-AP MLD 11 is able to receive the de-enablement command even if the AP MLD 11 sends the de-enablement command exclusively in the license-exempt frequency band 320.

In some scenarios, it may occur that there are too many devices, e.g., single-link non-AP STAs and non-AP MLDs, that are enabled in the licensed frequency band 310. In such cases, the AP MLD 10 may apply an algorithm to attempt de-enablement of some of the devices. For example, such algorithm can first de-enable one or more single-link non-AP STAs by sending a de-enablement command in the licensed frequency band 310, and then for one or more non-AP MLDs that have an affiliated STA operating on the licensed frequency band 310 but being in a power-save mode, the AP MLD 11 may send a de-enablement command on a link in the license-exempt frequency band 320.

In some scenarios, the de-enablement may be automatically controlled based on a de-enablement timer, such as the timer “dot11DSERenewalTime” specified in the IEEE 802.11 Standard. Such de-enablement timer may be re-started based on receiving frames on a link in the licensed frequency band 310, and expiry of the de-enablement timer may trigger the automatic de-enablement. However, the non-AP MLD 11 could have its affiliated non-AP STA(s) operating on the licensed frequency band 310 in a power-save mode, so that the non-AP MLD 11 is not able to receive any frames in the licensed frequency band 310. As consequence, the non-AP MLD 11 could be automatically de-enabled, even though it still receives frames in the license-exempt frequency band 320. In some cases, the de-enablement timer can be re-started by receiving a frame from the AP MLD 10 on a link outside the licensed frequency band 310. It is also possible to define a de-enablement timer which is dedicated for non-AP MLDs having a link in the licensed frequency band 310 and another link outside the licensed frequency band 310, e.g., in the license-exempt frequency band 320.

In some cases, certain traffic classes may be mapped to corresponding links of an MLD. For example, in the WLAN technology a non-AP MLD and its associated AP MLD may negotiate a mapping of a certain TID to certain link, which is denoted as TID-to-Link-Mapping. IEEE contribution “TID to Link Mapping enhancements”, document IEEE 802.11-21/1611r0 for example describes the following: A default mapping is “all-to-all”, meaning that all TIDs are mapped to all links available at the MLD. Further, there are various flavors of non-default mappings. A non-AP MLD can have the following capabilities: no capability for non-default mapping, a general TID mapping capability in which the non-AP MLD supports mapping each TID to the same or different link sets (e.g., TID 1 on link 1 and link 2, TID 2 only on link 2, etc.), an all-TID-to-link-subset mapping in which the non-AP MLD needs to map all TIDs to the same link set (e.g., TID 0-7 all on link 2). Further enhancements may help the non-AP MLD and the AP MLD to agree on various kinds of TID-to-link mappings. This may for example help to achieve load balancing in the network, to reduce latency by assigning critical traffic TIDs to reserved channels, and to provide further possibilities of power saving.

In the illustrated concepts, it may be beneficial to make sure that some TID-to-link mapping configurations are accepted without negotiation between the AP MLD 10 and the non-AP MLD 11. In this way, it can for example be avoided that the non-AP MLD 11 faces unfavorable conditions when operating on both in the licensed frequency band 310 and the and license-exempt frequency band 320.

In some scenarios, if the non-AP MLD 11 has signaled, e.g., in the ML association request 321, that it wants to establish a link in the licensed frequency band 310, the AP MLD 10 can be mandated to establish that link, if available. Such mandatory link establishment can be configured in the AP MLD 10. In some cases. if the non-AP MLD 11 signals a TID-to-link-mapping which involves that a TID is mapped to the link in the licensed frequency band 310, the AP MLD 10 may be mandated to accept the TID-to-link-mapping. Alternatively or in addition, the AP MLD 10 may be mandated to accept at least one TID mapped to the link in the licensed frequency band 310. Alternatively or in addition, there may be a standardized or configurable limit on how many TIDs may be mapped to the link in the licensed frequency band 310.

In some scenarios, it may occur that the non-AP MLD 11 cannot trigger connection on the licensed frequency band 310 by using signaling in the license-exempt frequency band 320. In such situations, only the AP MLD 10 could be allowed to signal, e.g., in the ML association response, that a certain link in the licensed frequency band 310 should be configured or can be configured. The non-AP MLD 11 may however signal that it has the capability to use a link in the licensed frequency band, e.g., for example, in a the ML association request 321. The non-AP MLD 11 may in some cases also refuse the configuration of the link in the licensed frequency band 310. The latter information could for example be signaled in an ML association response from the non-AP MLD 11 to the AP MLD 10. The limitation of certain signaling to be performed only by the AP MLD 10 may be useful, e.g., in order to align with regulations for licensed frequency bands as for example given in the IEEE 802.11y Amendment. One possibility to implement such limitation of signaling would be to specify in a standard that only AP MLDs may signal, e.g., in an association response or in a beacon, information about channels available in certain frequency bands, specifically licensed frequency bands. This may for example enable the AP MLD 10 to manage traffic load or number of STAs associated over a channel in the licensed frequency band 310.

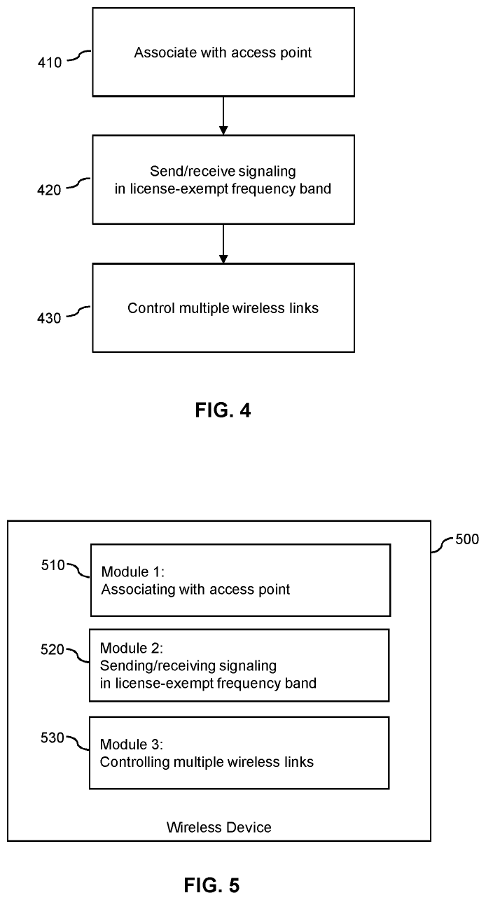

FIG. 4 shows a flowchart for illustrating a method of controlling wireless transmissions in a wireless communication system, which may be utilized for implementing the illustrated concepts. The method of FIG. 4 may be used for implementing the illustrated concepts in a wireless device operating in a wireless communication system, e.g., one of the above-mentioned stations 11. The wireless device may in particular correspond to the above-mentioned non-AP MLD 11. The wireless communication system may be based on a wireless local area network, WLAN, technology, e.g., according to the IEEE 802.11 standards family.

If a processor-based implementation of the wireless device is used, at least some of the steps of the method of FIG. 4 may be performed and/or controlled by one or more processors of the wireless device. Such wireless device may also include a memory storing program code for implementing at least some of the below described functionalities or steps of the method of FIG. 4.

At step 410, the wireless device associates with an AP of the wireless communication system. The wireless device and the AP may both support operation in a license-exempt frequency band and in a licensed frequency band. The AP may be registered to operate in the licensed frequency band and permission of the wireless device to transmit in the licensed frequency band may depend on the AP. The licensed frequency band may for example correspond to the 3.65 GHz band. The wireless device and the AP may be MLDs and thus support simultaneous operation on multiple wireless links between the wireless device and the AP, such as the above-mentioned links 315, 325 in FIG. 3C.

At step 420, the wireless device sends and/or receives control signaling in a license-exempt frequency band, e.g., as illustrated by messages 321 and 322 in the examples of FIGS. 3A and 3B. In some scenarios, step 420 may also involve that the wireless device sends and/or receives control signaling in a licensed frequency band.

The signaling in the license-exempt frequency band may include signaling for associating the wireless device to the AP. For example, such association signaling may include an association request from the wireless device to the AP and/or an association response from the AP to the wireless device.

In addition or as an alternative, the signaling in the license-exempt frequency band may include signaling for reconfiguration of at least one of the wireless links between the wireless device and the AP. For example, such reconfiguration signaling may include an reconfiguration request from the wireless device to the AP and/or a reconfiguration response from the AP to the wireless device. Further, such reconfiguration signaling may include an reconfiguration request from the AP to the wireless device and/or a reconfiguration response from the wireless device to the AP.

In addition or as an alternative, the signaling in the license-exempt frequency band may include an enablement message from the AP. Such enablement message may indicate that usage of the licensed frequency band by the wireless device is allowed.

In addition or as an alternative, the signaling in the license-exempt frequency band may include a de-enablement message from the AP. Such de-enablement message may indicate that usage of the licensed frequency band by the wireless device is not, or no longer, allowed.

In some scenarios, usage of the licensed frequency band by the wireless device may be allowed until expiry of a timer maintained by the wireless device. In such cases, the signaling in the license-exempt frequency band may cause re-starting of the timer. An example of such timer is the above-mentioned timer “dot11DSERenewalTime”. However, it would also be possible to utilize a newly defined timer for this purpose. In some cases, the timer may be started both by signaling in the license-exempt frequency band and by signaling in the licensed frequency band.

In some scenarios, the signaling in the license-exempt frequency band may include information provided by the wireless device to configure a mapping of one or more traffic types to the wireless links between the wireless device and the AP, e.g., in terms of a TID-to-link mapping.

In some scenarios, the signaling in the licensed frequency band may include information provided by the AP to indicate that signaling for associating the wireless device to the AP is to be performed in the license-exempt frequency band.

In some scenarios, the signaling in the licensed frequency band may include information provided by the AP to enable access of the wireless device to the licensed frequency band.

In some scenarios, the signaling in the license-exempt frequency band may include information provided by the AP to enable access of the wireless device to the licensed frequency band.

The information provided by the AP may include at least one of: information concerning a license to use the licensed frequency band, information concerning a location of the access point, information concerning a transmit power limitation in the licensed frequency band, information concerning medium access requirements in the licensed frequency band, and information concerning regulatory requirements in the licensed frequency band. At least a part of the information provided by the AP can be conveyed in one or more broadcast messages from the AP.

At step 430, the wireless device controls multiple wireless links between the wireless device and the AP. The multiple wireless links include at least one wireless link in the license-exempt frequency band and an additional wireless link in a licensed frequency band, such as the above-mentioned wireless links 315, 325. The control of the wireless links at step 430 is based on the signaling of step 420, in particular the signaling in the license-exempt frequency band.

In some cases, the control of multiple wireless links, in particular the additional wireless link, may be further based on signaling in the licensed frequency band, e.g., as explained in connection with step 420. The control of the multiple wireless links may for example involve establishing the additional wireless link or releasing the additional wireless link.

FIG. 5 shows a block diagram for illustrating functionalities of a wireless device 500 which operates according to the method of FIG. 4. The wireless device 500 may correspond to one of the above-mentioned stations 11, in particular to the above-mentioned non-AP MLD 11. As illustrated, the wireless device 500 may be provided with a module 510 configured to associate with an AP, such as explained in connection with step 410. Further, the wireless device 500 may be provided with a module 520 configured to send and/or receive signaling, such as explained in connection with step 420. Further, the wireless device 500 may be provided with a module 530 configured to control multiple wireless links, such as explained in connection with step 430.

It is noted that the wireless device 500 may include further modules for implementing other functionalities, such as known functionalities of a non-AP STA in an IEEE 802.11 technology. Further, it is noted that the modules of the wireless device 500 do not necessarily represent a hardware structure of the wireless device 500, but may also correspond to functional elements, e.g., implemented by hardware, software, or a combination thereof.

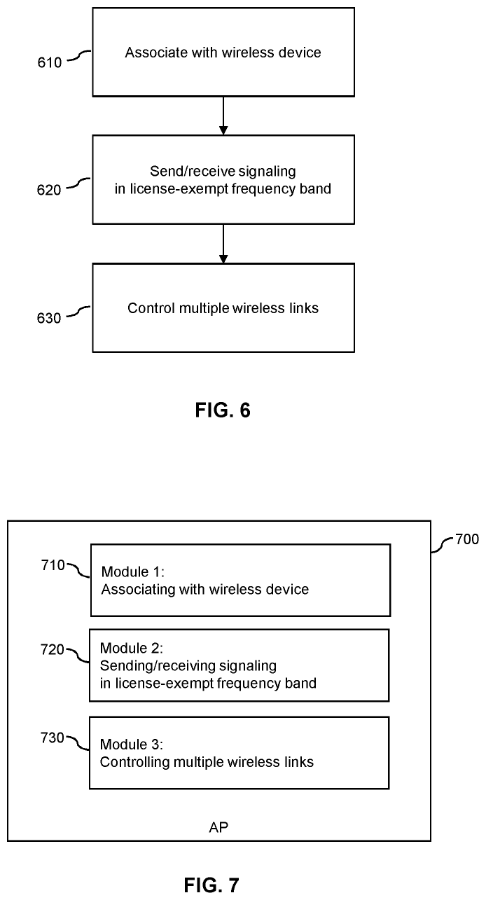

FIG. 6 shows a flowchart for illustrating a method of controlling wireless transmissions in a wireless communication system, which may be utilized for implementing the illustrated concepts. The method of FIG. 6 may be used for implementing the illustrated concepts in an AP of a wireless communication system, e.g., one of the above-mentioned APs 10, in particular the above-mentioned AP MLD 10. The wireless communication system may be based on a wireless local area network, WLAN, technology, e.g., according to the IEEE 802.11 standards family.

If a processor-based implementation of the AP is used, at least some of the steps of the method of FIG. 6 may be performed and/or controlled by one or more processors of the AP. Such AP may also include a memory storing program code for implementing at least some of the below described functionalities or steps of the method of FIG. 6.

At step 610, the AP associates with a wireless device, e.g., one of the above-mentioned stations 11. The wireless device may in particular correspond to the above-mentioned non-AP MLD 11. The wireless device and the AP may both support operation in a license-exempt frequency band and in a licensed frequency band. The AP may be registered to operate in the licensed frequency band and permission of the wireless device to transmit in the licensed frequency band may depend on the AP. The licensed frequency band may for example correspond to the 3.65 GHz band. The wireless device and the AP may be MLDs and thus support simultaneous operation on multiple wireless links between the wireless device and the AP, such as the above-mentioned links 315, 325.

At step 620, the AP sends and/or receives control signaling in a license-exempt frequency band, e.g., as illustrated by messages 321 and 322 in the examples of FIGS. 3A and 3B. In some scenarios, step 620 may also involve that the AP sends and/or receives control signaling in a licensed frequency band.

The signaling in the license-exempt frequency band may include signaling for associating the wireless device to the AP. For example, such association signaling may include an association request from the wireless device to the AP and/or an association response from the AP to the wireless device.

In addition or as an alternative, the signaling in the license-exempt frequency band may include signaling for reconfiguration of at least one of the wireless links between the wireless device and the AP. For example, such reconfiguration signaling may include an reconfiguration request from the wireless device to the AP and/or a reconfiguration response from the AP to the wireless device. Further, such reconfiguration signaling may include an reconfiguration request from the AP to the wireless device and/or a reconfiguration response from the wireless device to the AP.

In addition or as an alternative, the signaling in the license-exempt frequency band may include an enablement message from the AP. Such enablement message may indicate that usage of the licensed frequency band by the wireless device is allowed.

In addition or as an alternative, the signaling in the license-exempt frequency band may include a de-enablement message from the AP. Such de-enablement message may indicate that usage of the licensed frequency band by the wireless device is not, or no longer, allowed.

In some scenarios, usage of the licensed frequency band by the wireless device may be allowed until expiry of a timer maintained by the wireless device. In such cases, the signaling in the license-exempt frequency band may cause re-starting of the timer. An example of such timer is the above-mentioned timer “dot11DSERenewalTime”. However, it would also be possible to utilize a newly defined timer for this purpose. In some cases, the timer may be started both by signaling in the license-exempt frequency band and by signaling in the licensed frequency band.

In some scenarios, the signaling in the license-exempt frequency band may include information provided by the wireless device to configure a mapping of one or more traffic types to the wireless links between the wireless device and the AP, e.g., in terms of a TID-to-link mapping.

In some scenarios, the signaling in the licensed frequency band may include information provided by the AP to indicate that signaling for associating the wireless device to the AP is to be performed in the license-exempt frequency band.

In some scenarios, the signaling in the licensed frequency band may include information provided by the AP to enable access of the wireless device to the licensed frequency band.

In some scenarios, the signaling in the license-exempt frequency band may include information provided by the AP to enable access of the wireless device to the licensed frequency band.

The information provided by the AP may include at least one of: information concerning a license to use the licensed frequency band, information concerning a location of the access point, information concerning a transmit power limitation in the licensed frequency band, information concerning medium access requirements in the licensed frequency band, and information concerning regulatory requirements in the licensed frequency band. At least a part of the information provided by the AP can be conveyed in one or more broadcast messages from the AP.

At step 630, the AP controls multiple wireless links between the wireless device and the AP. The multiple wireless links include at least one wireless link in the license-exempt frequency band and an additional wireless link in a licensed frequency band, such as the above-mentioned wireless links 315, 325. The control of the wireless links at step 630 is based on the signaling of step 620, in particular the signaling in the license-exempt frequency band. In some cases, the control of the multiple wireless links, in particular the additional wireless link, may be further based on signaling in the licensed frequency band, e.g., as explained in connection with step 620. The control of the multiple wireless links may for example involve establishing the additional wireless link or releasing the additional wireless link.

FIG. 7 shows a block diagram for illustrating functionalities of an AP 700 which operates according to the method of FIG. 6. The AP 700 may correspond to one of the above-mentioned APs 10. As illustrated, the AP 700 may be provided with a module 710 configured to associate with a wireless device, such as explained in connection with step 610. Further, the AP 700 may be provided with a module 720 configured to send and/or receive signaling, such as explained in connection with step 620. Further, the AP 700 may be provided with a module 730 configured to control multiple wireless links, such as explained in connection with step 630.

It is noted that the AP 700 may include further modules for implementing other functionalities, such as known functionalities of an AP in an IEEE 802.11 technology. Further, it is noted that the modules of the AP 700 do not necessarily represent a hardware structure of the wireless AP 700, but may also correspond to functional elements, e.g., implemented by hardware, software, or a combination thereof.

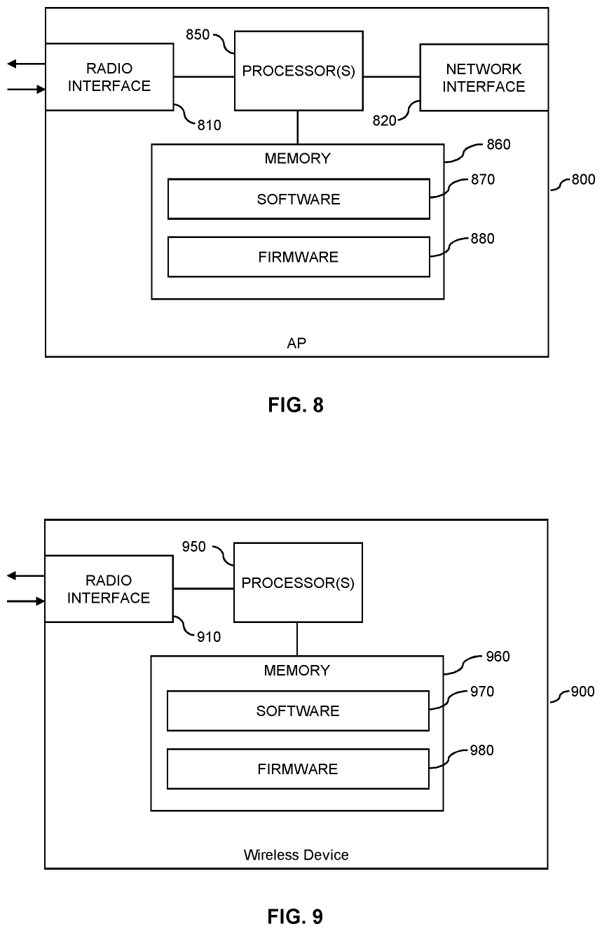

FIG. 8 illustrates a processor-based implementation of an AP 800. The structures as illustrated in FIG. 8 may be used for implementing the above-described concepts. The AP 800 may for example correspond to one of above-mentioned APs 10, in particular the above-mentioned AP MLD 10.

As illustrated, the AP 800 includes a radio interface 810. The radio interface 810 may for example be based on a WLAN technology, e.g., according to an IEEE 802.11 family standard. However, other wireless technologies could be supported as well, e.g., the LTE technology or the NR technology. Further, the AP 800 is provided with a network interface 820 for connecting to a data network, e.g., using a wire-based connection.

Further, the AP 800 may include one or more processors 850 coupled to the interfaces 810, 820, and a memory 860 coupled to the processor(s) 850. By way of example, the interfaces 810, 820, the processor(s) 850, and the memory 860 could be coupled by one or more internal bus systems of the AP 800. The memory 860 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. As illustrated, the memory 860 may include software 870 and/or firmware 880. The memory 860 may include suitably configured program code to be executed by the processor(s) 850 so as to implement the above-described functionalities for controlling wireless transmissions, such as explained in connection with the method of FIG. 6.

It is to be understood that the structures as illustrated in FIG. 8 are merely schematic and that the AP 800 may actually include further components which, for the sake of clarity, have not been illustrated, e.g., further interfaces or further processors. Also, it is to be understood that the memory 860 may include further program code for implementing known functionalities of an AP in an IEEE 802.11 technology. According to some embodiments, also a computer program may be provided for implementing functionalities of the AP 800, e.g., in the form of a physical medium storing the program code and/or other data to be stored in the memory 860 or by making the program code available for download or by streaming.

FIG. 9 illustrates a processor-based implementation of a wireless device 900. The structures as illustrated in FIG. 9 may be used for implementing the above-described concepts. The wireless device 900 may for example correspond to one of above-mentioned stations 11. The wireless device 900 may correspond to a non-AP STA, in particular the above-mentioned non-AP MLD 11.

As illustrated, the wireless device 900 includes a radio interface 910. The radio interface 910 may for example be based on a WLAN technology, e.g., according to an IEEE 802.11 family standard. However, other wireless technologies could be supported as well, e.g., the LTE technology or the NR technology.

Further, the wireless device 900 may include one or more processors 950 coupled to the interface 910 and a memory 960 coupled to the processor(s) 950. By way of example, the interface 910, the processor(s) 950, and the memory 960 could be coupled by one or more internal bus systems of the wireless device 900. The memory 960 may include a ROM, e.g., a flash ROM, a RAM, e.g., a DRAM or SRAM, a mass storage, e.g., a hard disk or solid state disk, or the like. As illustrated, the memory 960 may include software 970 and/or firmware 980. The memory 960 may include suitably configured program code to be executed by the processor(s) 950 so as to implement the above-described functionalities for controlling wireless transmissions, such as explained in connection with the method of FIG. 9.

It is to be understood that the structures as illustrated in FIG. 9 are merely schematic and that the wireless device 900 may actually include further components which, for the sake of clarity, have not been illustrated, e.g., further interfaces or further processors. Also, it is to be understood that the memory 960 may include further program code for implementing known functionalities of a non-AP STA in an IEEE 802.11 technology. According to some embodiments, also a computer program may be provided for implementing functionalities of the wireless device 900, e.g., in the form of a physical medium storing the program code and/or other data to be stored in the memory 960 or by making the program code available for download or by streaming.

As can be seen, the concepts as described above may be used for efficiently enabling operation on multiple wireless links in both a licensed frequency band and a license-exempt frequency band. In particular, it becomes possible to control multiple wireless links in the licensed frequency band and the license-exempt frequency band in an efficient manner, by using signaling in the license-exempt frequency band.

It is to be understood that the examples and embodiments as explained above are merely illustrative and susceptible to various modifications. For example, the illustrated concepts may be applied in connection with various kinds of wireless technologies, without limitation to WLAN technologies. Further, the concepts may be also be applied with respect to any number of wireless links between MLDs and to various numbers and kinds of license-exempt and licensed frequency bands. Moreover, it is to be understood that the above concepts may be implemented by using correspondingly designed software to be executed by one or more processors of an existing device or apparatus, or by using dedicated device hardware. Further, it should be noted that the illustrated apparatuses or devices may each be implemented as a single device or as a system of multiple interacting devices or modules.

1-42. (canceled)

43. A method of controlling wireless transmissions in a wireless communication system, implemented by a wireless device, the method comprising:
associating with an access point of the wireless communication system; and
based on signaling in a license-exempt frequency band, controlling multiple wireless links between the wireless device and the access point, the multiple wireless links comprising at least one wireless link in the license-exempt frequency band and an additional wireless link in a licensed frequency band.

44. The method of claim 43, wherein the signaling in the license-exempt frequency band comprises signaling for associating the wireless device to the access point.

45. The method of claim 43, wherein the signaling in the license-exempt frequency band comprises signaling for reconfiguration of at least one of the wireless links between the wireless device and the access point.

46. The method of claim 43, wherein the signaling in the license-exempt frequency band comprises an enablement message from the access point, indicating that usage of the licensed frequency band by the wireless device is allowed.

47. The method of claim 43, wherein the signaling in the license-exempt frequency band comprises a de-enablement message from the access point, indicating that usage of the licensed frequency band by the wireless device is not allowed.

48. The method of claim 43, wherein:
usage of the licensed frequency band by the wireless device is allowed until expiry of a timer maintained by the wireless device, and
the signaling in the license-exempt frequency band causes re-starting of the timer.

49. The method of claim 43, wherein said signaling in the license-exempt frequency band comprises information provided by the access point to enable access of the wireless device to the licensed frequency band.

50. The method of claim 43, wherein said signaling in the license-exempt frequency band comprises information provided by the wireless device to configure a mapping of one or more traffic types to the wireless links between the wireless device and the access point.

51. The method of claim 43, wherein said controlling of the multiple wireless links comprises establishing or releasing the additional wireless link.

52. A method of controlling wireless transmissions in a wireless communication system, implemented by an access point of the wireless communication system, the method comprising:
associating with a wireless device; and
based on signaling in an license-exempt frequency band, controlling multiple wireless links between the wireless device and the access point, the multiple wireless links comprising at least one wireless link in the license-exempt frequency band and an additional wireless link in a licensed frequency band.

53. The method of claim 52, wherein the signaling in the license-exempt frequency band comprises signaling for associating the wireless device to the access point.

54. The method of claim 52, wherein the signaling in the license-exempt frequency band comprises signaling for reconfiguration of at least one of the wireless links between the wireless device and the access point.

55. The method of claim 52, wherein the signaling in the license-exempt frequency band comprises an enablement message from the access point, indicating that usage of the licensed frequency band by the wireless device is allowed.

56. The method of claim 52, wherein the signaling in the license-exempt frequency band comprises a de-enablement message from the access point, indicating that usage of the licensed frequency band by the wireless device is not allowed.

57. The method of claim 52, wherein:
usage of the licensed frequency band by the wireless device is allowed until expiry of a timer maintained by the wireless device; and
the signaling in the license-exempt frequency band causes re-starting of the timer.

58. The method of claim 52, wherein said signaling in the license-exempt frequency band comprises information provided by the access point to enable access of the wireless device to the licensed frequency band.

59. The method of claim 52, wherein said signaling in the license-exempt frequency band comprises information provided by the wireless device to configure a mapping of one or more traffic types to the wireless links between the wireless device and the access point.

60. The method of claim 52, wherein said controlling the multiple wireless links comprises establishing or releasing the additional wireless link.

61. A wireless device for a wireless communication system, the wireless device comprising:
at least one processor; and
a memory containing program code executable by the at least one processor, whereby execution of the program code by the at least one processor causes the wireless device to:
associate with an access point of the wireless communication system; and
based on signaling in an license-exempt frequency band, control multiple wireless links between the wireless device and the access point, the multiple wireless links comprising at least one wireless link in the license-exempt frequency band and an additional wireless link in a licensed frequency band.

62. An access point for a wireless communication system, the access point comprising:
at least one processor; and
a memory containing program code executable by the at least one processor, whereby execution of the program code by the at least one processor causes the access point to:
associate with a wireless device; and
based on signaling in an license-exempt frequency band, control multiple wireless links between the wireless device and the access point, the multiple wireless links comprising at least one wireless link in the license-exempt frequency band and an additional wireless link in a licensed frequency band.
